(19) United States
(12) Patent Application Publication
(10) Pub. No.: US 2015/0192217 A1
(43) Pub. Date: Jul. 9, 2015

(54) ELECTROMAGNETIC VALVE

(71) Applicants: Masakuni Suzuki, Toyota-shi (JP); Masaki Nanahara, Toyota-shi (JP); Kei Sato, Kasuga-shi (JP); Katsuhiro Kanamori, Miyoshi-shi (JP); Takeshi Ishida, Nagakute-shi (JP)

(72) Inventors: Masakuni Suzuki, Toyota-shi (JP); Masaki Nanahara, Toyota-shi (JP); Kei Sato, Kasuga-shi (JP); Katsuhiro Kanamori, Miyoshi-shi (JP); Takeshi Ishida, Nagakute-shi (JP)

(73) Assignee: TOYOTA JIDOSHA KABUSHIKI KAISHA, Toyota-shi (JP)

(21) Appl. No.: 14/412,469

(22) PCT Filed: Jul. 2, 2012
(86) PCT No.: PCT/JP2012/066905

§ 371 Date: Jan. 2, 2015

(51) Int. Cl. F16K 31/06; F16K 11/04

(52) U.S. Cl. CPC F16K 31/0624; F16K 11/04

(57) ABSTRACT

An electromagnetic valve includes a housing, a valve element, a movable core, a spring, a coil, and a stationary core. The housing includes a cylinder portion that houses the movable core so that the movable core is movable in an axial direction. An axial intermediate portion of the cylinder portion is formed as a non-magnetic portion that surrounds an outer circumference of an axial intermediate portion of the movable core. Both axial sides of the non-magnetic portion are formed as a one-side magnetic portion and an another-side magnetic portion that surround an outer circumference of the movable core. An electromagnetic force in a direction perpendicular to the axial direction, for generating a friction resistance to axial movement of the movable core, is set to be generated by energization of the coil between the outer circumference of the movable core and the one-side magnetic portion of the cylinder portion on one axial side of the non-magnetic portion and between the outer circumference of the movable core and the another-side magnetic portion of the cylinder portion on another axial side of the non-magnetic portion.

### TECHNICAL FIELD

The present invention relates to an electromagnetic valve, for example, an electromagnetic valve to be assembled to hydraulic control equipment for a hydraulic brake device for a vehicle, and to be used for hydraulic control of a brake fluid (fluid).

### BACKGROUND ART

As one of this type of electromagnetic valves, there exists an electromagnetic valve that includes a housing having an inlet port and outlet ports for a fluid, a passage for bringing the inlet port and the outlet ports into communication with each other, a valve hole having a valve seat on one end portion, which is formed in the passage, and a cylinder portion coaxial with the valve hole, a valve element provided so as to be seatable on and unseatable from the valve seat, a movable core (also sometimes referred to as “plunger”) integral with the valve element, which is assembled to the cylinder portion so as to be movable in an axial direction, a spring for biasing the valve element and the movable core in a seating direction or an unseating direction relative to the valve seat, and a coil and a stationary core (also sometimes referred to as “solenoid”) for generating an electromagnetic force against a load of the spring for the movable core by energization. The electromagnetic valve is described in, for example, Patent Literature 1.

In the electromagnetic valve described in Patent Literature 1, the movable core (plunger) includes an attracting portion made of a magnetic substance, which is configured so that an attracting force in an axial direction acts between the attracting portion and the housing when the coil is energized, and a sliding portion made of a magnetic substance, which moves while sliding in the axial direction relative to an inner wall of the housing when the coil is energized. Moreover, a sectional area of the sliding portion in a direction crossing the axial direction is set smaller than a sectional area of the attracting portion in the direction crossing the axial direction. Therefore, in the electromagnetic valve described in Patent Literature 1, a friction force in the sliding portion, which can be obtained by the energization of the coil, can be appropriately suppressed. As a result, the suppression of self-excited oscillation can be realized, while desired sliding performance can be realized in the sliding portion.

### CITATION LIST

### Patent Literature

[PTL 1] JP 2011-12808 A

### SUMMARY OF INVENTION

By the way, in the electromagnetic valve described in Patent Literature 1, both the attracting portion and the sliding portion, which have different sectional areas in the direction crossing the axial direction, are required to be provided to the movable core (plunger) so as to obtain the above-mentioned functions and effects. In addition to the portions described above, an attracting-portion housing section and a sliding-portion housing section, which have different sectional areas in the direction crossing the axial direction, are required to be provided to the cylinder portion of the housing. In the electromagnetic valve described in Patent Literature 1, however, an outer circumference of the attracting portion (one end portion) of the movable core (plunger) is surrounded by a non-magnetic portion provided to the cylinder portion of the housing. Therefore, on one axial side (stationary-core side) of the non-magnetic portion, an electromagnetic force in a direction perpendicular to the axial direction (radial direction), for generating a friction resistance to the axial movement of the movable core (plunger), cannot be generated between an outer circumference of an axial end portion that is in connection with the one end portion of the movable core (plunger) and an inner circumference of the housing. Therefore, for adjustment to increase or decrease the friction force obtained by the energization of the coil, a shape of the movable core (plunger), the housing, or the like is required to be changed.

The present invention has been made to solve the problems described above (specifically, to provide an electromagnetic valve that does not need to change a shape of a movable core (plunger), a housing, or the like for adjustment to increase or decrease the above-mentioned friction force obtained by energization of a coil).

According to one embodiment of the present invention, there is provided an electromagnetic valve, including:

a housing having an inlet port and an outlet port for a fluid, a passage for bringing the inlet port and the outlet port into communication with each other, a valve hole having a valve seat formed on one end portion, the valve hole being formed in the passage, and a cylinder portion coaxial with the valve hole;

a valve element provided so as to be seatable on and unseatable from the valve seat;

a movable core integral with the valve element, and assembled to the cylinder portion so as to be movable in an axial direction;

a spring for biasing the valve element and the movable core in a seating direction or an unseating direction relative to the valve seat; and

a coil and a stationary core for generating an electromagnetic force against a load of the spring for the movable core by energization,

in which an axial intermediate portion (one portion) of the cylinder portion is formed as a non-magnetic portion (may also be a space) surrounding an outer circumference of an axial intermediate portion (one portion) of the movable core, and

in which both axial sides of the non-magnetic portion are formed as a one-side magnetic portion and an another-side magnetic portion that surround an outer circumference of the movable core.

In the electromagnetic valve according to one embodiment of the present invention, when the coil is energized, the electromagnetic force (attracting force) in a direction perpendicular to the axial direction (radial direction) can be generated between an outer circumference of an axial end portion that is in connection with one end portion of the movable core and the one-side magnetic portion of the cylinder portion, whereas the electromagnetic force (attracting force) in the direction perpendicular to the axial direction (radial direction) can be generated between an outer circumference of another axial side of the movable core and the another-side magnetic portion of the cylinder portion. Therefore, when the coil is energized, a desired electromagnetic force (attracting force) for generating a desired friction, resistance to the axial movement of the movable core can be constantly applied to the movable core on both axial sides (two portions) of the non-magnetic portion that is set to the cylinder portion of the housing. Thus, the friction force in the movable direction (axial direction) can be constantly and appropriately applied to the movable core. As a result, self-excited oscillation along with the oscillation of the movable core can be suppressed.

By the way, the electromagnetic valve according to one embodiment of the present invention is configured to provide the above-mentioned functions and effects by forming the axial intermediate portion (one portion) of the cylinder portion of the housing as the non-magnetic portion (may also be a space) that surrounds the outer circumference of the axial intermediate portion (one portion) of the movable core and forming the both axial sides of the non-magnetic portion as the one-side magnetic portion and the another-side magnetic portion that surround the outer circumference of the movable core. Therefore, the above-mentioned friction force obtained by the energization of the coil can be adjusted to be increased or decreased by the adjustment of the arrangement of the non-magnetic portion in the cylinder portion of the housing. Thus, for the above-mentioned adjustment to increase or decrease the friction force, the shapes of the housing, the valve element, the movable core, and the like of the electromagnetic valve are not required to be changed. Thus, the electromagnetic valve is easy to manufacture at low costs.

For carrying out the present invention described above, a thin sleeve made of a non-magnetic substance may also be provided between the outer circumference of the movable core and an inner circumference of the cylinder portion. In this case, the movable core and the cylinder portion can be prevented from being magnetically directly coupled to each other. As a result, excessive magnetic adhesion of the movable core to the cylinder portion can be prevented. Moreover, in this case, the thin sleeve may also be assembled to the outer circumference of the movable core and omitted on the one end portion of the movable core, which is opposed to the stationary core. In this case, one end portion of the thin sleeve can be prevented from projecting beyond the one end portion of the movable core so as to prevent the one end portion of the thin sleeve from coming into contact with the stationary core. Moreover, the one end portion of the thin sleeve can be prevented from sliding on a portion in which magnetic property changes (between the non-magnetic portion and the magnetic portion). As a result, a contact load (friction resistance) can be stabilized.

### BRIEF DESCRIPTION OF DRAWINGS

FIG. 1 is a longitudinal sectional view illustrating an electromagnetic valve (normally-closed electromagnetic valve) according to an embodiment of the present invention.

FIG. 2 is an enlarged sectional view schematically illustrating a magnetic path formed in the electromagnetic valve illustrated in FIG. 1 when a coil is energized.

### DESCRIPTION OF EMBODIMENTS

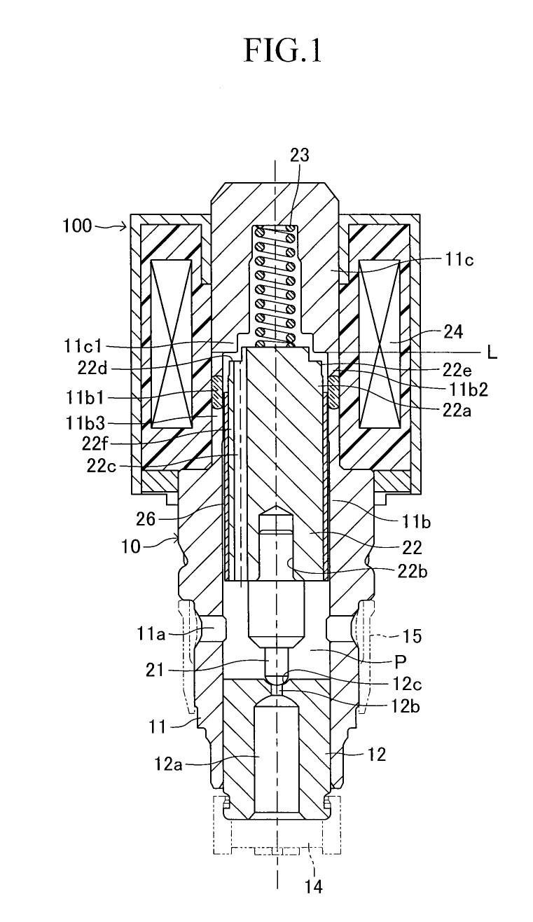

Now, an embodiment of the present invention is described referring to the drawings. FIG. 1 illustrates an electromagnetic valve according to the embodiment of the present invention. An electromagnetic valve 100 is, for example, a normally-closed electromagnetic valve to be assembled to hydraulic control equipment for a hydraulic brake device for a vehicle, and to be used for hydraulic control of a brake fluid. In the electromagnetic valve 100, a valve element 21, a movable core 22, a spring 23, a coil 24, and the like are assembled to a housing 10.

The housing 10 includes a housing main body 11 having a cylindrical shape, and a seat member 12 having a cylindrical shape, which is assembled to an inner circumference of a lower end portion of the housing main body 11 in FIG. 1 so as to be positionally adjustable in a vertical direction. The housing main body 11 houses the valve element 21, the movable core 22, the spring 23, and the like therein. A plurality of outlet ports 11a for a fluid are formed on a side of a lower portion thereof in FIG. 1. The housing main body 11 includes a cylinder portion 11b provided above the outlet ports 11a, for housing the movable core 22 movably in an axial direction (vertical direction in FIG. 1), and a stationary core portion 11c for housing the spring 23 therein.

The cylinder portion 11b is made of a magnetic substance except for an axial intermediate portion (a portion thereof) 11b1. The axial intermediate portion 11b1 is formed as a non-magnetic portion that surrounds an outer circumference of an axial intermediate portion 22a of the movable core 22. When the axial intermediate portion 11b1 of the cylinder portion 11b is formed as the non-magnetic portion, the portion may be formed of a non-magnetic substance or a space. Alternatively, a surface portion of the portion (portion that is originally made of the magnetic substance) may also be reformed to be non-magnetized (for example, non-magnetized by melting a metal such as nickel or chromium onto the magnetic substance of the surface portion).

The seat member 12 is made of a non-magnetic substance. In an axial center portion, an inlet port 12a for the fluid is formed, while a valve hole 12b and a valve seat 12c are formed coaxially with the inlet port 12a. The inlet port 12a and the outlet ports 11a for the fluid can be brought into communication with each other through a passage P formed inside the housing 10. In the passage P, the valve hole 12b having the valve seat 12c (the valve hole 12b in which the valve seat 12c is arranged) on one end portion (upper end portion in FIG. 1) is formed. Moreover, a filter 14 is mounted onto the inlet port 12a, whereas filters 15 are mounted onto the outlet ports 11a. Therefore, in this embodiment, when the electromagnetic valve 100 is opened (when the valve element 21 separates away upward in FIG. 1 from the valve seat 12c), the fluid (brake fluid) flowing into the inlet port 12a through the filter 14 flows to the outlet ports 11a (flows in a self-opening direction) through the valve seat 12c and the valve hole 12b formed in the passage P to flow out of the housing 10 through the filters 15.

The valve element 21 is made of a non-magnetic substance and is provided so as to be seatable on and unseatable from the valve seat 12c (movable in the vertical direction in FIG. 1). The valve element 21 is fixedly fitted into a mounting hole 22b formed in a lower end portion of the movable core 22 so as to be movable integrally with the movable core 22. The movable core 22 is made of a magnetic substance having a columnar shape and is assembled to the cylinder portion 11b of the housing main body 11 so as to be movable in the axial direction (slidable in the vertical direction in FIG. 1). A thin sleeve 26 made of a non-magnetic substance is assembled to an outer circumference of the movable core 22. Moreover, in the movable core 22, a communication hole 22c for bringing a lower end in FIG. 1 (lower fluid chamber) and an upper end in FIG. 1 (upper fluid chamber) into communication with each other is formed.

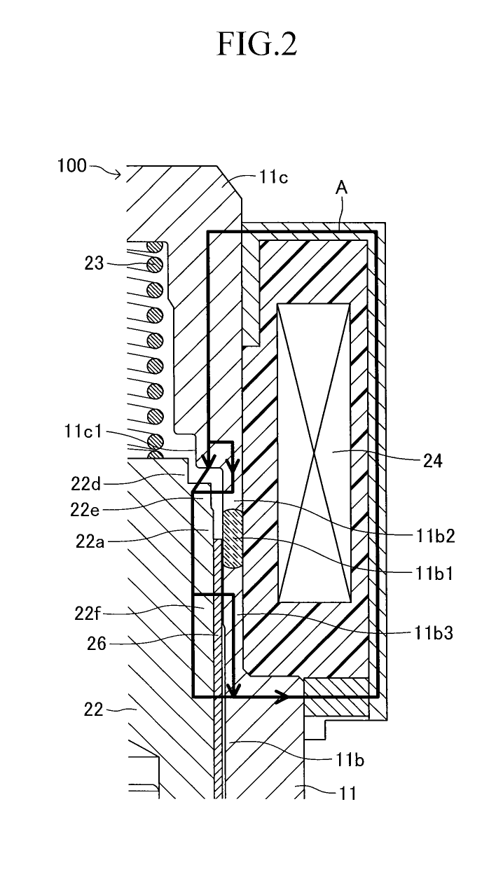

The spring 23 biases the valve element 21 and the movable core 22 in a seating direction relative to the valve seat 12c and is provided between the movable core 22 and the stationary core portion 11c. The coil 24 is provided over an outer circumference of an upper portion of the cylinder portion 11b in FIG. 1 and an outer circumference of the stationary core portion 11c of the housing main body 11. The cylinder portion 11b of the housing main body 11, the movable core 22, the stationary core portion 11c, and the like are configured to form a magnetic path A that is schematically illustrated in FIG. 2. The coil 24 and the stationary core portion 11c are configured to generate an electromagnetic force against a load of the spring 23 for the movable core 22 by the energization of the coil 24. In this embodiment, a portion located above a boundary line L illustrated in FIG. 1 is the stationary core portion 11c, whereas a portion located below the boundary line L illustrated in FIG. 1 is the cylinder portion 11b of the housing 10.

By the way, in this embodiment, a portion above and a portion below the non-magnetic portion 11b1 formed on the cylinder portion 11b of the housing main body 11 in FIG. 2 (specifically, both axial ends) are formed as a one-side magnetic portion 11b2 and an another-side magnetic portion 11b3 that surround the outer circumference of the movable core 22. Specifically, a position of an upper end of the non-magnetic portion 11b1 in FIG. 2 (position of an end surface on the stationary core side) is set lower than a lowermost surface of an end surface of an upper end portion of the movable core 22 in FIG. 2 (end surface opposed to the end surface of the stationary core in the axial direction) by a predetermined amount (at a position separated away by the predetermined amount).

On the upper side (one side in the axial direction) of the non-magnetic portion 11b1 in FIG. 2, by the energization of the coil 24, an electromagnetic force in the axial direction against the load of the spring 23 is set to be generated between an upper end level-difference portion (one end portion) 22d of the movable core 22 in FIG. 2 and a lower end level-difference portion (one end portion) 11c1 of the stationary core portion 11c in FIG. 2, whereas an electromagnetic force in a direction perpendicular to the axial direction, for generating a friction resistance to the axial movement of the movable core 22, is set to be generated between an outer circumference of an axial end portion 22e that is in connection with the one end portion of the movable core 22 and the one-side magnetic portion 11b2 of the cylinder portion 11b. The upper end level-difference portion (one end portion) 22d of the movable core 22 in FIG. 2 and the lower end level-difference portion (one end portion) 11c1 of the stationary core portion 11c in FIG. 2 are formed so that the upper portion has a smaller diameter than that of the lower portion.

Moreover, on a lower side (another side in the axial direction) of the non-magnetic portion 11b1 in FIG. 2, by the energization of the coil 24, an electromagnetic force in the direction perpendicular to the axial direction, for generating a friction resistance to the axial movement of the movable core 22, is set to be generated between an outer circumference of another axial side 22f of the movable core 22 (outer circumference of a portion onto which the thin sleeve 26 is assembled) and the another-side magnetic portion 11b3 of the cylinder portion 11b.

In the electromagnetic valve 100 according to this embodiment, which is configured as described above, when the coil 24 is energized, the electromagnetic force in the direction perpendicular to the axial direction can be generated between the outer circumference of the axial end portion 22e that is in connection with the one end portion of the movable core 22 and the one-side magnetic portion 11b2 of the cylinder portion 11b. Moreover, the electromagnetic force in the direction perpendicular to the axial direction can be generated between the outer circumference of the another axial side 22f of the movable core 22 and the another-side magnetic portion 11b3 of the cylinder portion 11b. Each of the above-mentioned electromagnetic forces in the direction perpendicular to the axial direction is generated in a portion in which a gap in the radial direction decreases by the movement of the valve element 21 and the movable core 22 in any radial direction relative to the housing 10 (or inclination with the valve element 21 side as a point of support) when the valve element 21 separates away from the valve seat 12c as a result of the energization of the coil 24 and the generation of a change in gap in the radial direction between the movable core 22 and the cylinder portion 11b along with the movement. Under a state in which the valve element 21 separates away from the valve seat 12c by the energization of the coil 24, an attracting force in the axial direction, an attracting force in the direction perpendicular to the axial direction, the spring load, a fluid force, a friction force, and the like act on the valve element 21 and the movable core 22. As a result, a pressure and a flow rate of the fluid flowing from the inlet port 12a to the outlet ports 11a are controlled in accordance with a current to energize the coil 24.

Therefore, when the coil 24 is energized, a desired electromagnetic force for generating a desired friction resistance to the axial movement of the movable core 22 can be constantly applied to the movable core 22 on both axial sides (two portions) of the non-magnetic portion 11b1 that is set to the cylinder portion 11b of the housing 10. Therefore, the friction force in the movable direction (axial direction) can be constantly and appropriately applied to the movable core 22. Thus, self-exited oscillation along with the oscillation of the movable core 22 can be suppressed.

By the way, the electromagnetic valve 100 according to this embodiment is configured to provide the above-mentioned functions and effects by forming the axial intermediate portion of the cylinder portion 11b of the housing 10 as the non-magnetic portion 11b1 that surrounds the outer circumference of the axial intermediate portion 22a of the movable core 22 and forming the both axial sides of the non-magnetic portion 11b1 as the one-side magnetic portion 11b2 and the another-side magnetic portion 11b3 that surround the outer circumference of the movable core 22. Therefore, the above-mentioned friction force obtained by the energization of the coil 24 can be adjusted to be increased or decreased by the adjustment of the arrangement of the non-magnetic portion 11b1 in the cylinder portion 11b of the housing 10. Therefore, for the above-mentioned adjustment to increase or decrease the friction force, the shapes of the housing 10, the valve element 21, the movable core 22, and the like of the electromagnetic valve 100 are not required to be changed. Thus, the electromagnetic valve 100 is easy to manufacture at low costs.

Moreover, in the electromagnetic valve 100 according to this embodiment, the thin sleeve 26 made of the non-magnetic substance is provided between the outer circumference of the movable core 22 and the inner circumference of the cylinder portion 11b. Therefore, the movable core 22 and the cylinder portion 11b can be prevented from being magnetically directly coupled to each other. Hence, the excessive magnetic adhesion of the movable core 22 to the cylinder portion 11b can be prevented. Moreover, in the electromagnetic valve 100 of this embodiment, the thin sleeve 26 is assembled to the outer circumference of the movable core 22 and is omitted on the upper end portion (one end portion) of the movable core 22 in FIG. 2, which is opposed to the stationary core portion 11c. Therefore, the one end portion of the thin sleeve 26 can be prevented from projecting beyond the one end portion of the movable core 22 so as to prevent the one end portion of the thin sleeve 26 from coming into contact with the stationary core portion 11c. Moreover, the one end portion of the thin sleeve 26 can be set to slide only on the non-magnetic portion 11b1 and prevented from sliding on the portion in which the magnetic property changes (between the non-magnetic portion 11b1 and the one-side magnetic portion 11b2). As a result, the contact load (friction resistance) can be stabilized.

In the electromagnetic valve 100 according to the embodiment described above, the present invention has been carried out with the housing 10 including the housing main body 11 and the seat member 12. However, the configuration of the housing may be appropriately changed and is not limited to that of the embodiment described above. Moreover, in the embodiment described above, the present invention has been carried out with the stationary core (11c) provided integrally with the housing main body 11. However, the configuration of the stationary core may be appropriately changed and is not limited to that of the embodiment described above.

Moreover, in the embodiment described above, the present invention has been carried out for the normally-closed electromagnetic valve. However, the present invention may also be carried out even for a normally-open electromagnetic valve in a similar manner or with an appropriate change. Moreover, in the embodiment described above, the thin sleeve 26 is assembled to the outer circumference of the movable core 22 and is omitted on the upper end portion (one end portion) of the movable core 22 in FIG. 2. However, the configuration of the thin sleeve may be appropriately changed. For example, the present invention may be carried out with the thin sleeve provided even up to the upper end portion of the movable core 22 in FIG. 2 and may also be carried out with the thin sleeve provided to the housing main body side.

As described above, in brief, for carrying out the present invention, the configuration (for example, configuration such as the number or arrangement of springs or the like) may be appropriately changed except that the axial intermediate portion of the cylinder portion (11b) is formed as the non-magnetic portion (11b1) that surrounds the outer circumference of the axial intermediate portion of the movable core (22) and that the both axial sides of the non-magnetic portion are formed as the one-side magnetic portion (11b2) and the another-side magnetic portion (11b3) that surround the outer circumference of the movable core, and therefore the present invention is not limited to the embodiment described above and the modifications described above.

1. An electromagnetic valve, comprising:
a housing having an inlet port and an outlet port for a fluid, a passage for bringing the inlet port and the outlet port into communication with each other, a valve hole having a valve seat formed on one end portion, the valve hole being formed in the passage, and a cylinder portion coaxial with the valve hole;
a valve element provided so as to be seatable on and unseatable from the valve seat;
a movable core integral with the valve element, and assembled to the cylinder portion so as to be movable in an axial direction;
a spring for biasing the valve element and the movable core in a seating direction or an unseating direction relative to the valve seat; and
a coil and a stationary core for generating an electromagnetic force against a load of the spring for the movable core by energization,
wherein an axial intermediate portion of the cylinder portion is formed as a non-magnetic portion surrounding an outer circumference of an axial intermediate portion of the movable core,
wherein both axial sides of the non-magnetic portion are formed as a one-side magnetic portion and an another-side magnetic portion that surround an outer circumference of the movable core,
wherein the electromagnetic valve further comprises a thin sleeve made of a non-magnetic substance, and provided between the outer circumference of the movable core and an inner circumference of the cylinder portion, and
wherein the thin sleeve is assembled to the outer circumference of the movable core and is omitted on one end portion of the movable core, which is opposed to the stationary core.

2-3. (canceled)
